(19) United States
(12) Patent Application Publication
(10) Pub. No.: US 2012/0265428 A1
(43) Pub. Date: Oct. 18, 2012

(54) VEHICLE MOTION ESTIMATING DEVICE, VEHICLE MOTION ESTIMATING METHOD, AND VEHICLE MOTION ESTIMATING PROGRAM

(75) Inventors: Tomoyuki Zaitsu, Okazaki (JP); Shinji Kachi, Okazaki (JP); Kenji Nagase, Okazaki (JP); Tsuyoshi Iwata, Nagoya (JP); Toshio Inoguchi, Nagoya (JP); Kazunori Watanabe, Okazaki (JP); Teruhide Hayashida, Shinagawa-ku (JP)

(73) Assignee: AISIN AW CO., LTD., Anjo-shi, Aichi-ken (JP)

(21) Appl. No.: 13/202,503

(22) PCT Filed: Feb. 22, 2010
(86) PCT No.: PCT/JP2010/000365

§ 371 Date: Oct. 13, 2011

(30) Foreign Application Priority Data
Feb. 19, 2009 (JP) 2009036066

(51) Int. Cl. G08G 1/00

(52) U.S. Cl. 701/118; 701/117

(57) ABSTRACT

According to the present invention, information which is associated with a motion of a vehicle can be acquired even in the case where no vehicle travels on a road. Motion information, which is associated with the motion of the vehicle on the road where the vehicle traveled, is acquired along with time information. Reference traffic information, which is traffic information on the road at a reference time which is specified by the time information, is acquired from a traffic information providing device which constantly provides the traffic information. A correlation between the motion information and the reference traffic information is specified. Furthermore, estimated motion information, which indicates an estimated motion of the vechicle on the road at an estimate time when the motion is estimated, is acquired based on estimating source traffic information at the estimate time and the correlation, the estimating source traffic information being provided as the traffic information of the estimating source from the traffic information providing device in the case where no motion information is acquired at the estimate time.

### TECHNICAL FIELD

The present invention relates to a vehicle motion estimating device, a vehicle motion estimating method, and a vehicle motion estimating program.

### BACKGROUND ART

Conventionally, there has been known technologies for transmitting time-series position data, which reflects a degree of traffic jam in a traffic lane in which a vehicle is present, and time data from the vehicle (e.g., Patent Citation 1). In this technique, the degree of traffic jam is specified in each traffic lane based on the time-series data.

### CITATION LIST

### Patent Literature

PTL 1: Japanese Patent Application Publication No. 2004-272839

### SUMMARY OF INVENTION

### Technical Problem

The conventional techniques employ the configuration in which vehicle position data is transmitted from the vehicle. Thus, a degree of traffic jam can be acquired for a traffic lane in which the vehicle traveled, and in other words, the degree of traffic jam cannot be specified unless the vehicle travels in the traffic lane. In addition, the vehicles capable of transmitting the position data are not very popular at present. Therefore, it is unrealistic to always acquire the position data in the traffic lane for which the degree of traffic jam is to be specified, and it is actually impossible to specify the degree of traffic jam at any time in a desired traffic lane based on the information transmitted from the vehicle via the conventional techniques.

In light of the aforementioned problem, an object of the present invention is to provide the technique for acquiring the information which is associated with the motion of the vehicle even in the case where no vehicle travels on the road.

### Solution to Problem

To attain the object, in the present invention, motion information is acquired and reference traffic information is acquired from a traffic information providing device which constantly provides traffic information. A correlation between the motion information and the reference traffic information is specified in advance so that estimated motion information is acquired based on the correlation and estimating source traffic information which is the traffic information of the estimating source. Summing up, the present invention is configured to estimate the motion of the vehicle at an estimate time from the estimating source traffic information, which is different from the reference traffic information, based on the correlation between the motion information and the reference traffic information.

In the present invention, since the reference traffic information is acquired from a traffic information providing device, which constantly provides the traffic information, the reference traffic information can be acquired at any time regardless of the presence of the vehicles traveling on a road. Therefore, when the motion information on at least one vehicle is acquired, the correlation between the motion information and the reference traffic information can be specified. On the other hand, the estimating source traffic information is also acquired from the traffic information providing device, which constantly provides the traffic information. Therefore, the estimating source traffic information can be acquired at any time regardless of the presence of the vehicles traveling on the road. As a result, the estimated motion information, which is associated with the motion of the vehicle, can be acquired even in the case where no vehicle traveling on the road is present.

In the present invention, a motion information acquiring unit may be configured in any manner as long as the unit acquires the motion information, which is associated with the motion of the vehicle on the road where the vehicle traveled, along with time information. The motion information may be the information which directly or indirectly indicates the motion of the vehicle. The former would be the information on the speed and positions of the vehicle, and the latter would be the information on the results of the motion of the vehicle (e.g., the time required in the predetermined section) and the conditions which affect the motion of the vehicle (e.g., the degree of traffic jam in the predetermined section). Moreover, the time information may be any information as long as the information indicates the time associated with the motion information, and, for example, may be the information which indicates the time when the vehicle conducts the motion, or the time when the motion information is created or transmitted, or, in addition, the time when the motion information acquiring unit acquires the motion information.

A reference traffic information acquiring unit may be configured in any manner as long as the unit acquires the traffic information on the aforementioned road at a reference time, which is specified by the time information, from the traffic information providing device which constantly provides the traffic information, to use the traffic information as the reference traffic information. In other words, the unit may be configured in any manner as long as the unit acquires the traffic information indicating the traffic condition which affects the motion of the vehicle indicated by the motion information, to use the traffic information as the reference traffic information. Note that the traffic information indicates the traffic condition of the roads and is constantly provided. As a result, even though the motion information indicates the motion associated with any time, the traffic information indicating the traffic condition which affects the motion can be acquired at any time.

The traffic information may be any information as long as the information indicates the traffic condition which affects the vehicle traveling on roads, and may be the information indicating the condition which affects the motion of the vehicle, or may be the information indicating the affected motion of the vehicle. In the former case, for example, the degree of traffic jam in the predetermined section would be included in the traffic information, and in the latter case, for example, the speed and positions of the vehicle, and the time required in the predetermined section would be included therein.

The reference time may be any time as long as the time is specified by the time information. Specifically, when the traffic condition affects the motion of the vehicle at a given time, such a given time may be set at the reference time. Therefore, the same time as the time indicated by the time information which is associated with the motion information may be set at the reference time. Moreover, whenever the traffic condition indicated by the reference traffic information affects the motion of the vehicle, the time prior to and after the time indicated by the time information can be set at the reference time.

A correlation specifying unit may be configured in any manner as long as the unit specifies the correlation between the motion information and the reference traffic information. The traffic condition indicated by the reference traffic information affects the motion of the vehicle. The motion information indicates the motion of the affected vehicle. In other words, the motion information can be considered as depending on the reference traffic information. So, the correlation is defined such that the motion information can be derived from the reference traffic information. In this configuration, it is considered that the correlation is established between the traffic condition and the motion of the vehicle in the traffic condition, and thereby the motion information associated with any traffic information can be acquired.

An estimated motion information acquiring unit may be configured in any manner as long as the unit acquires the estimated motion information, which is associated with the estimate time, based on the estimating source traffic information and the correlation. Specifically, the correlation, which is specified such that the motion information can be derived from the traffic information, is applied to the estimating source traffic information, and thereby the motion information specified by the correlation is considered as the estimated motion information at a desired estimate time.

The estimate time may be any time as long as the time is different from the time indicated by the time information. Since the motion information, which is associated with the time indicated by the time information, is already acquired, a desired time, which is different from the time indicated by the time information, may be defined as the estimate time. For example, in the case where the present motion of the vehicle is estimated, the configuration in which the current time is set at the estimate time can be employed. Alternatively, on the assumption of some estimating source traffic information, the estimated motion information, which is associated with the estimating source traffic information, is acquired in advance, and then any time when the traffic condition indicated by said some estimating source traffic information occurs may be set at the estimate time. The estimating source traffic information may indicate any traffic condition which affects the motion of the vehicle at the estimate time, and may be the traffic information at the same time as the estimate time, or may be the traffic information in the time period which may affect the motion of the vehicle at the estimate time.

Moreover, the correlation may be specified and the estimated motion may be acquired based on the information on each unit section. For example, consider the configuration in which the motion information and the estimated motion information are defined for a certain unit section, and the reference traffic information and the estimating source traffic information are defined for the plurality of unit sections including such a certain unit section. Acquiring the correlation between the motion information on the aforementioned certain unit section and the reference traffic information on the plurality of unit sections including such a certain unit section, the motion information can be estimated from the traffic information on the plurality of unit sections. Moreover, when the correlation is applied to the estimating source traffic information on the plurality of unit sections including the aforementioned certain unit section, the estimated motion information on the certain unit section can be acquired. In the configuration, since the reference traffic information and the estimating source traffic information are defined for the plurality of unit sections, the traffic information would change individually in each of the plurality of unit sections. As a result, the reference traffic information and the estimating source traffic information can be defined as an index for evaluating the effect on the motion of the vehicle.

The unit section may be any section as long as the section constitutes the minimum section to define each of the motion information, the estimated motion information, the reference traffic information, and the estimating source traffic information. In other words, it may be sufficient to define each of the motion information, the estimated motion information, the reference traffic information, and the estimating source traffic information on each of the unit sections on the roads which are divided in advance. The unit section may be any section which is set on the roads and used to define the information, and may be a section divided by unit distance or a section which is set on the roads in advance and divided by any distance.

Moreover, consider the configuration in which the motion information, the estimated motion information, the reference traffic information, and the estimating source traffic information indicate any of the speed of vehicle, the time required in the predetermined section and the degree of traffic jam in the predetermined section. By employing the configuration in which the speed of vehicle, the time required and the degree of traffic jam are defined for each unit section, the speed of vehicle, the time required and the degree of traffic jam can be easily defined.

Moreover, the correlation may indicate any relation between the reference traffic information and the motion information, and the various relations can be acquired as the correlation as long as the estimated motion information can be acquired from the estimating source traffic information. For example, the present invention may employ the configuration in which a value associated with the motion information is acquired by adding values, which are obtained by multiplying each value associated with the reference traffic information on each of the plurality of unit sections, by the coefficients. In this configuration, each coefficient expresses the correlation. Specifically, considering that the motion information and the reference traffic information are converted into numerical values, and a linear combination of the value given by the reference traffic information on each unit section provides the motion information. Thus, the correlation can be easily defined by the coefficients used in the linear combination. Each coefficient can be specified by multiple regression analysis, learning using neural network model, various approximation methods, or the like.

Moreover, the present invention may employ the configuration in which the motion information associated with the combinations of the reference traffic information on the plurality of unit sections is specified to establish the correlation. In the case where the traffic information is defined for each section constituted by the plurality of unit sections, the combinations of the traffic information for each section constituted by the plurality of unit sections may vary by the time. If the traffic information has the same pattern in the plurality of unit sections, the motions of the vehicle associated with the traffic information are estimated to be similar motions. Therefore, in the case where the reference traffic information is considered as an occurrence pattern of the traffic information on the plurality of unit sections, the correlation can be defined only by associating the reference traffic information with the motion information. As a result, the correlation can be very easily defined.

Moreover, the motion information may be defined for each leaving direction from the intersection. For example, consider the configuration in which the motion information including the information indicating the leaving direction from the intersection is acquired from the plurality of vehicles, in the case where the vehicle passes through the intersection. In addition, the motion information is classified by leaving direction, the correlation is acquired for each classification of the leaving direction, and moreover the estimated motion information is acquired for the vehicle leaving in the leaving direction associated with the classification from the intersection, based on the estimating source traffic information and the correlation for each classification.

When comparing the vehicles which travel in the different leaving directions after passing through the intersection, the vehicles will have different motions. In addition, in this case, the vehicles which are traveling in the same leaving direction will have the similar motion. Thus, when the motion information is classified by leaving direction to acquire the correlation for each classification, it is possible to specify the correlation based on which the estimated motion information can be accurately acquired from the estimating source traffic information. As a result, the estimated motion information for each leaving direction can be more accurately specified.

Furthermore, the motion information may be defined for each traffic lane of the road where the vehicle traveled. For example, consider the configuration in which the motion information including the information indicating the traffic lane of the road where the vehicle traveled is acquired from the plurality of vehicles. Moreover, the motion information is classified by traffic lane, and the correlation is acquired for each classification of the traffic lane. Then, the estimated motion information on the traffic lane, which is associated with the classification, is acquired based on the estimating source traffic information and the correlation for each classification.

Even the same traffic information, the condition indicated by the traffic information may affect the vehicles for each traffic lane in which the vehicle travels in different ways. For example, in the case where heavy traffic is present on one lane of four-lane while less traffic is on the other lane, the vehicles have different motions depending on the traffic lane in which the vehicle travels. In addition, in this case, the vehicles traveling in the same traffic lane have the similar motion. Thus, in the case where the motion information is classified by traffic lane to acquire the correlation for each classification, it is possible to specify the correlation based on which the estimated motion information can be accurately acquired from the estimating source traffic information. As a result, the estimated motion information can be more accurately specified for each traffic lane. Note that the traffic information may or may not include the information indicating the traffic lane of the road where the vehicle traveled.

Moreover, the present invention may employ the configuration in which the motion of the vehicle is estimated before and after the vehicle passes through the predetermined feature. For example, the motion information is acquired from a location before the vehicle arrives at the intersection on the road to the intersection, and the reference traffic information is acquired from the location before the vehicle arrives at the intersection to a location after the vehicle passes through the intersection, so as to acquire the correlation. In this configuration, the correlation between the reference traffic information and the motion information can be defined in view of the effect of the traffic condition before and after the arrival at the intersection.

Moreover, consider the configuration in which the estimated motion information is acquired in association with the section from the location before the vehicle arrives at the intersection to the intersection, based on the correlation defined via the afore-mentioned configuration and the estimating source traffic information which is associated with the section from the location before the vehicle arrives at the intersection to the location after the vehicle passes through the intersection. With this configuration, the motion of the vehicle can be estimated in view of the effect of the traffic condition before and after the arrival at the intersection. As a result, the motion of the vehicle can be accurately estimated.

It is possible to apply, to a method for performing the processing and a program, the techniques for acquiring the estimated motion information from the estimating source traffic information based on the correlation between the predefined motion information and the reference traffic information, as disclosed in the present invention. The foregoing vehicle motion estimating device, method, and program are provided as a single device in some cases and as a plurality of devices in other cases. Moreover, the vehicle motion estimating device, method, and program include various aspects; they are provided using the common component to each part constituting the vehicle, or are provided in cooperation with any unit which is not mounted on the vehicle. Moreover, it is possible to change the present invention appropriately such as partially software and partially hardware. Furthermore, the invention is also realized as a recording medium of the program controlling the vehicle motion estimating device. Of course, the recording medium of the software may be magnetic recording medium or magneto-optical medium, and any recording medium to be developed in the future can be assumed in the totally same manner.

### BRIEF DESCRIPTION OF DRAWINGS

FIG. 1 is a block diagram illustrating a vehicle motion estimating device;

FIG. 2 is a flow chart illustrating a processing for acquiring correlation;

FIG. 3 is a flow chart illustrating a processing for acquiring estimated motion information; and

FIG. 4 is a diagram illustrating unit sections which are set on roads.

### BEST MODE FOR CARRYING OUT THE INVENTION

Here, embodiments of the present invention will be described in the following order:

(1) Configuration of Traffic Information Management System

(1-1) Configuration of Navigation System

(1-2) Configuration of Vehicle Motion Estimating Device

(1-3) Processing for Specifying Correlation

(1-4) Processing for Acquiring Estimated Motion Information

(2) Other Embodiments

### (1) Configuration of Traffic Information Management System

(1-1) Configuration of Navigation System

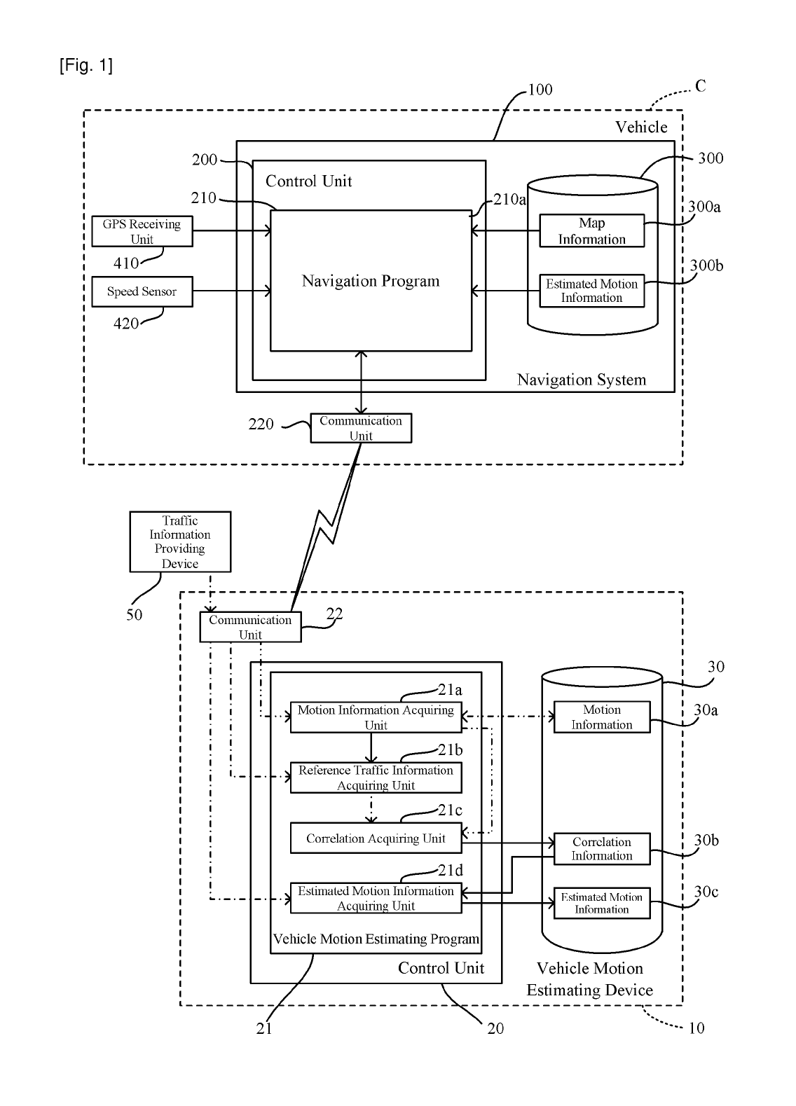

FIG. 1 is a block diagram illustrating a configuration of a system comprising a navigation system 100 equipped in a vehicle C and a vehicle motion estimating device 10, which is placed in the motion information control center. The navigation system 100 is mounted on a plurality of vehicles C traveling on roads. The navigation system 100 comprises a control unit 200 having CPU, RAM, ROM or the like, and a recording medium 300. The control unit 200 can execute programs stored on the recording medium 300 or ROM. In this embodiment, a navigation program 210 is executable as one of the programs.

Moreover, the vehicle C comprises a communication unit 220 which is made up of a circuit for communicating with the vehicle motion estimating system 10, and the control unit 200 can communicate with the vehicle motion estimating device 10 by a processing of the navigation program 210. In addition, the vehicle C comprises a GPS receiving unit 410 and a speed sensor 420. The GPS receiving unit 410 receives radio waves from a GPS satellite, and outputs information for calculating the current position of the vehicle via interface (not shown). The speed sensor 420 outputs a signal associated with the rotational speed of the wheel of the vehicle C. The control unit 200 specifies the current position of the vehicle C based on the output signal of the GPS receiving unit 410 and the speed sensor 420, and acquires the speed of the vehicle C.

The control unit 200 can conduct route search based on map information 300a recorded on the recording medium 300 by the processing of the navigation program 210. Moreover, the control unit 200 generates motion information indicating the motion of the vehicle C during the traveling through the processing of the navigation program 210, and transmits the motion information to the vehicle motion estimating device 10. Furthermore, the control unit 200 acquires estimated motion information created by the vehicle motion estimating device 10 through the processing of the navigation program 210 and records the estimated motion information on the recording medium 300 (which is referred to as estimated motion information 300b), to use the estimated motion information for the route search or the like.

The map information 300a is recorded on the recording medium 300, and the map information 300a includes node data indicating nodes which are set on the roads where the vehicles travel, link data indicating the connection between the nodes, facility data indicating facilities where may be a destination of a planned traveling route, or the like. Therefore, the control unit 200 can specify a road section corresponding to the linkage based on the node data and the link data indicated by the map information 300a, indicate the map in each road section, and moreover specify the position of the vehicle in each road section. Note that the node data includes data indicating whether each node is at the intersection, and the control unit 200 can thus specify the intersections on the roads with reference to such data.

In this embodiment, the motion information transmitted to the vehicle motion estimating device 10 is the information indicating the speed of the vehicle C traveling in a unit section which is set to the roads surrounding the intersection. With the motion information, time information and information on leaving direction of the vehicle C at the intersection are associated. Therefore, the control unit 200 acquires the position and the speed of the vehicle C specified based on the output signal of the GPS receiving unit 410 and the speed sensor 420, and acquires a current time based on the output of a clock circuit (not shown) so as to maintain a history of the position and the speed of the vehicle C in association with the time. In addition, the control unit 200 determines whether the vehicle C passes through the intersection based on the map information 300a. Determining that the vehicle C passes through the intersection, the control unit 200 defines endpoints of a unit section at every unit distance from the intersection on the roads before and after the intersection, and regards the section between the endpoints as the unit section.

Moreover, the control unit 200 specifies an average speed from the history of the speed of the vehicle C in each unit section, and associates the average speed with the time information which indicates the time when the vehicle C travels in each unit section (e.g., the passing time through the reference point defined for each unit section), so as to generate the motion information. Furthermore, the control unit 200 associates the motion information with the information indicating a leaving direction, which corresponds to the traveling direction of the vehicle C after the passage of the intersection.

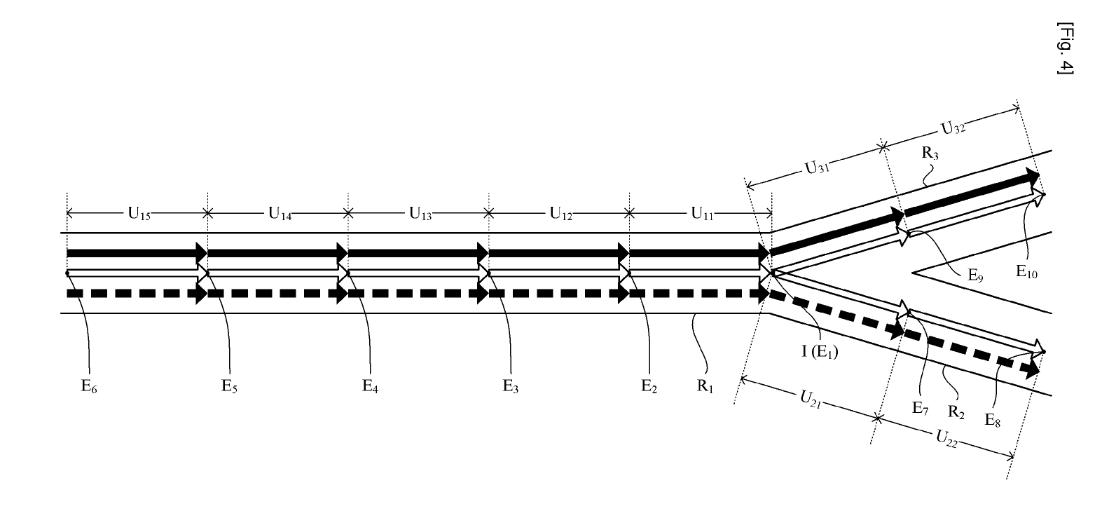

FIG. 4 illustrates unit sections set on roads, and the motion information is schematically shown by the arrows. Specifically, FIG. 4 shows roads R₁ to R₃ which intersect at an intersection I. More specifically, FIG. 4 shows an example in the case of the vehicle C traveling from the road R₁ to the road R₂ or the road R₃, in which the end points of the unit sections before and after the intersection I are defined as E₁ to E₁₀. In the example shown in FIG. 4, there is shown two unit sections U₂₁ and U₂₂, and U₃₁ and U₃₂ defined for the roads R₂ and R₃, respectively after the intersection I, and five unit sections U₁₁ to U₁₅ defined for the road R₁ before the intersection I.

In FIG. 4, the dashed arrows denote the motion information of the vehicle which turns right and leaves the intersection I. In other words, the motion information shown by the dashed arrows is associated with the information indicating the leaving direction in turning right and leaving the intersection I. Likewise, the solid arrows denote the motion information of the vehicle which turns left and leaves the intersection I. In other words, the motion information shown by the solid arrows is associated with the information indicating the leaving direction in turning left and leaving the intersection I.

After generating such motion information, the control unit 200 transmits the motion information to the vehicle motion estimating device 10. The aforementioned configuration is of course merely an example. For example, the present invention may be configured such that the information indicating the traveling history is transmitted to the vehicle motion estimating device 10, where the motion information is generated.

The estimated motion information 300b provides an estimate value of the speed of the vehicle traveling in the unit section. The estimate value of the speed of the vehicle indicated by the estimated motion information 300b corresponds to the ease of traveling on roads. Therefore, the control unit 200 associates the estimate value with cost information defined for every road sections such that the higher the speed of the vehicle is, the larger the value of the cost information becomes, so that the route search is conducted based on the cost information.

(1-2) Configuration of Vehicle Motion Estimating Device

The vehicle motion estimating device 10 comprises a control unit 20 having CPU, RAM, ROM or the like, and a recording medium 30. The control unit 20 can execute programs stored on the recording medium 30 or ROM. In this embodiment, the control unit 20 can execute one of the programs, a vehicle motion estimating program 21, by which the control unit 20 receives the motion information indicating the motion of the vehicle C from the vehicle C, and creates the estimated motion information indicating the estimated motion of the vehicle in any unit section.

The vehicle motion estimating device 10 comprises a communication unit 22 which is made up of a circuit for communicating with the vehicle C and a traffic information providing device 50 that constantly provides traffic information. In this embodiment, the traffic information is created and constantly provided by the traffic information providing device 50. The traffic information is constantly specified by sensors installed on the roads, and indicates an average speed of the vehicle, which travels in each unit section, for every unit sections on the road. The control unit 20 can acquire the traffic information on any unit section at present or at any time prior to the present from the traffic information providing device 50. Therefore, even though the motion information transmitted by the vehicle C indicates the motion associated with at any time, it is possible to acquire the traffic information which indicates the traffic condition that affects the motion in any case. Note that when the traffic information is defined for each section constituting a plurality of unit sections in the aforementioned manner, the traffic information may change individually in each of the plurality of unit sections, and thus a variety of conditions can be expressed by the traffic information defined for the plurality of unit sections. As a result, the traffic information can be defined as an index for evaluating the effect on the motion of the vehicle.

In FIG. 4, the outline arrows denote examples of the traffic information. Specifically, in FIG. 4, the traffic information is defined for every unit sections separated by the end points E₁ to E₁₀ on the roads R₁ to R₃. In this embodiment, the traffic information indicates the average speed of the vehicle in each unit section, and indicates the average speed of each vehicle traveling in a traveling direction on the roads R₁ to R₃. However, the traffic information does not reflect leaving directions after the intersection. More specifically, the traffic information on every unit sections on the road R₁ is the information generated based on both the vehicles traveling toward the road R₂ and the vehicles traveling toward the road R₃ after traveling on the road R₁.

Meanwhile, the motion information transmitted from the vehicle C to the vehicle motion estimating device 10 as described above is associated with the information indicating the leaving directions of the vehicle C from the intersection. Therefore, it is possible to identify the roads R₂, R₃ on which the vehicle traveling on the road R₁ will travel next. Summing up, the motion information describes the conditions of the vehicle on the roads more detail than the traffic information, but is not transmitted to the vehicle motion estimating device 10 unless the vehicle C passes through the intersection. On the other hand, the traffic information does not include the information on the leaving direction from the intersection, but can be constantly acquired from the traffic information providing device 50.

The vehicle motion estimating program 21 comprises a motion information acquiring unit 21a, a reference traffic information acquiring unit 21b, a correlation acquiring unit 21c, and an estimated motion information acquiring unit 21d. The motion information acquiring unit 21a is a module for providing the control unit 20 with a function that allows the acquisition of the motion information, which is associated with the motion of the vehicle C on the road where the vehicle C traveled, together with the time information. The control unit 20 acquires the motion information including the aforementioned time information that is transmitted from the vehicle C via the communication unit 22 by a processing of the motion information acquiring unit 21a, and records the motion information on the recording medium 30 (motion information 30a). In addition, the control unit 20 acquires the motion information 30a recorded on the recording medium 30 so as to use the motion information 30a as a processing object by the correlation acquiring unit 21c. The flow of the motion information is indicated by the two-dot chain lines in FIG. 1.

The reference traffic information acquiring unit 21b is a module for providing the control unit 20 with a function that allows the extraction of the information at a reference time, which is specified by the time information, from the traffic information providing device 50 which constantly provides the traffic information, and the acquisition of reference traffic information that is the traffic information on the roads before and after the intersection. In this embodiment, it is considered that the vehicle traveling in the specified unit section at a certain time is affected by other vehicles traveling at the same time. Accordingly, the same time as the time indicated by the time information associated with the motion information 30a is defined as the reference time. Therefore, the control unit 20 acquires, as the reference traffic information, the traffic information at the time indicated by the time information which is associated with the motion information 30a among the traffic information provided by the traffic information providing device 50.

Moreover, it is considered that the vehicle traveling in the specified unit section is affected by other vehicles which travel in a plurality of unit sections before and after the specified unit section. Accordingly, the control unit 20 acquires the reference traffic information on the plurality of unit sections including the specified unit section in association with the motion information 30a on the specified unit section. The control unit 20 acquires such reference traffic information to use the reference traffic information as a processing object by the correlation acquiring unit 21c. The flow of the traffic information is indicated by the dashed lines.

The correlation acquiring unit 21c is a module for providing the control unit 20 with a function that allows the identification of the correlation between the motion information and the reference traffic information. In this embodiment, the correlation between the motion information and the reference traffic information is specified by specifying coefficients by multiple regression analysis. Specifically, the reference traffic information indicates the average speed in each of the plurality of unit sections, as described above, and the speed of the vehicle indicated by the motion information is considered as depending on the average speed indicated by the reference traffic information. Thus, the speed of the vehicle indicated by the motion information 30a can be calculated by adding the values which are obtained by multiplying the average speeds by coefficients, and the control unit 20 specifies the coefficients by a technique of the multiple regression analysis. Acquiring the information on the coefficients, the control unit 20 records the information on the recording medium 30 as correlation information 30b.

Since the motion information 30a is associated with the information indicating the leaving direction from the intersection, the control unit 20 classifies the motion information 30a into the information associated with the same leaving direction, and acquires the correlation for each classification. For example, in the example shown in FIG. 4, in the case where both the motion information 30a denoted by the solid arrows and the motion information 30a denoted by the dashed arrows are acquired, the control unit 20 acquires both the correlation of the motion information 30a denoted by the solid arrows and the correlation of the motion information 30a denoted by the dashed arrows.

The estimated motion information acquiring unit 21d is a module for providing the control unit 20 with a function that allows the acquisition of the estimated motion information, which indicates the estimated motion of the vehicles on the roads at an estimate time that is different from the time indicated by the time information, based on estimating source traffic information, which is provided as the traffic information used for estimating the motion information from the traffic information providing device, and the correlation. This embodiment employs the configuration in which the motion of the vehicle is estimated on the assumption that the current time is the estimate time. In the case where the time indicated by the time information associated with the motion information 30a is any time in the predetermined period prior to the current time (including the current time), the control unit 20 does not estimate the motion of the vehicle. In other words, in the case where the time indicated by the time information associated with the motion information 30a is any time in the predetermined period prior to the current time (including the current time), it is considered that the motion information 30a indicates the motion of the vehicle at the current time.

In contrast, in the case where the time indicated by the time information associated with the motion information 30a is not a time in the predetermined period prior to the current time (including the current time), the control unit 20 estimates the motion of the vehicle. Specifically, the control unit 20 acquires the estimating source traffic information which indicates the average speed in the plurality of unit sections at the current time via the communication unit 22 from the traffic information providing device 50. Note that the plurality of unit sections are the unit sections including the unit section where the motion is to be estimated. Summing up, the control unit 20 acquires the traffic information on the plurality of unit sections as the estimating source traffic information which indicates the traffic condition that affects the motion of the vehicle at the estimate time.

Moreover, the control unit 20 acquires the correlation, which is associated with the leaving direction of the object to be estimated, with reference to the correlation information 30b recorded on the recording medium 30. In the example shown in FIG. 4 for example, the control unit 20 acquires the correlation specified in association with the solid arrows in estimating the motion of the vehicle which turns left at the intersection I, and acquires the correlation specified in association with the dashed arrows in estimating the motion of the vehicle which turns right at the intersection I.

The control unit 20 then acquires the estimated motion information based on the acquired estimating source traffic information and the acquired correlation, and records the estimated motion information on the recording medium 30 (estimated motion information 30c). Each of the vehicles which travel in the different leaving directions after passing through the intersection I is considered as having different motions. Likewise, in this case, the vehicles which travel in the same leaving direction are considered as having the similar motion. Then, this embodiment employs the configuration in which the motion information is classified by leaving direction to acquire the correlation for each classification. The estimated motion information is acquired from the estimating source traffic information based on the correlation, and thereby the estimated motion information can be accurately specified for each leaving direction.

Furthermore, the control unit 20 accepts a request to send the estimated motion information 30c from the vehicle C. Accepting such request to send, the control unit 20 extracts the estimated motion information 30c on the requested unit section, and sends the estimated motion information 30c to the vehicle C. The estimated motion information 30c sent is recorded on the recording medium 300 as the estimated motion information 300b in the vehicle C.

In the above configuration, the reference traffic information is acquired from the traffic information providing device 50 which constantly provides the traffic information, and thus the reference traffic information can be acquired in any case regardless of the presence of the vehicle C traveling on the roads. Therefore, if the motion information 30a is acquired for at least one vehicle, it is possible to specify the correlation between the motion information 30a and the reference traffic information. The estimating source traffic information is also acquired from the traffic information providing device 50 which constantly provides the traffic information. Thus, the estimating source traffic information can be acquired at any time regardless of the presence of the vehicle traveling on the roads. As a result, it is possible to acquire the estimated motion information based on the estimating source traffic information and the correlation, and acquire the estimated motion information associated with the motion of the vehicle even in the case where no vehicle travels on the roads. Moreover, even in the case where no other vehicle travels on the road before a certain vehicle travels on the road, the vehicle can utilize the motion information defined in detail for each leaving direction from the intersection.

(1-3) Processing for Specifying Correlation

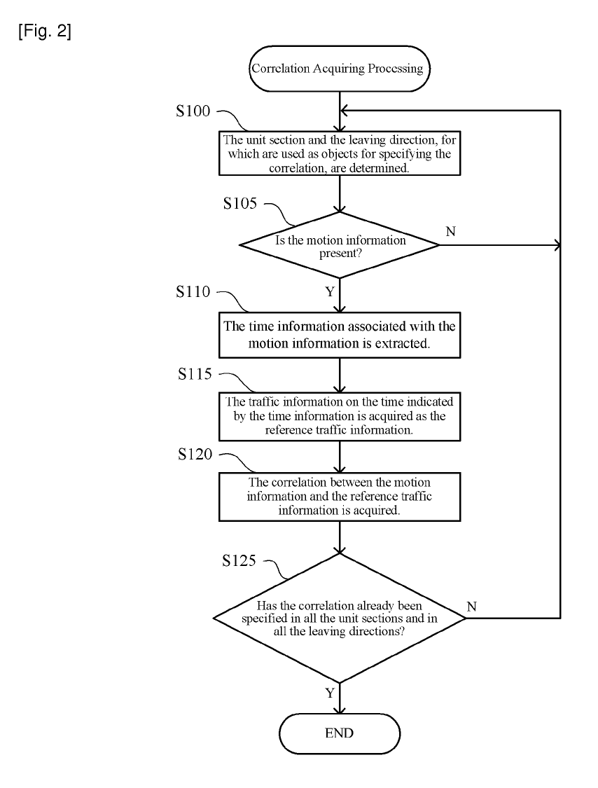

Next, a processing for specifying correlation, which is conducted such that the vehicle motion estimating device 10 acquires the correlation in the aforementioned configurations, will be described in detail. FIG. 2 is a flow chart illustrating the correlation specifying processing. The correlation specifying processing is regularly (e.g., monthly) conducted to specify the correlation. In this processing, the control unit 20 determines the unit section and the leaving direction, for which the correlation is to be specified, via the motion information acquiring unit 21a (Step S100). In this embodiment, the plurality of unit sections are set on the roads before and after the predetermined intersection, and the leaving direction from the intersection of the vehicle traveling in each unit section is defined in the motion information 30a. Then, in this embodiment, the correlation is specified for each leaving direction in each unit section. The control unit 20 uses the combination in which the correlation is not yet specified, among the combinations of the unit sections and the leaving directions, as an object for specifying the correlation.

Next, the control unit 20 determines whether there is the motion information 30a on the unit section and the leaving direction, for which the correlation is to be specified, with reference to the recording medium 30 via the processing of the motion information acquiring unit 21a (Step S105). In Step S105, when the control unit 20 determines there is no motion information 30a in the unit section and the leaving direction, for which the correlation is to be specified, the control unit 20 repeats Step S100 and the processing after Step S100. In other words, the similar processing is repeated using the combination in which the correlation is not yet specified, among the combinations of the unit sections and the leaving directions, as an object for specifying the correlation.

In Step S105, in case of determining that there is the motion information 30a on the unit section and the leaving direction, for which the correlation is to be specified, the control unit 20 extracts the time information associated with the motion information 30a on the unit section and the leaving direction, for which the correlation is to be specified, via the processing of the motion information acquiring unit 21a (Step S110).

Moreover, the control unit 20 acquires the traffic information at the time indicated by the extracted time information as the reference traffic information via the processing of the reference traffic information acquiring unit 21b (Step S115). Specifically, the control unit 20 specifies the plurality of unit sections including the unit section for which the correlation is to be specified, and acquires the traffic information, which is the traffic information on the plurality of unit sections and is associated with the time indicated by the above extracted time information, from the traffic information providing device 50 so as to use the traffic information as the reference traffic information. In this embodiment, on the road before the intersection, the unit section, for which the correlation is to be specified, and the unit sections within the predetermined range before and after the unit section are used as objects for acquiring the reference traffic information. On the roads after the intersection, the unit sections within the pre-determined range from the intersection are used as objects for acquiring the reference traffic information.

By using the unit sections within the predetermined range before and after the unit section, for which the correlation is to be specified, as an object for acquiring the reference traffic information, it is possible to specify the correlation, with limiting the range, within which the motion of the vehicle in the unit section, for which the correlation is to be specified, could be affected, to a certain range. On the road before the intersection, in the case where there is no unit section within all the predetermined ranges before and after the unit section for which the correlation is to be specified, the unit sections which are used as objects for acquiring the reference traffic information become fewer than in the case where there are unit sections within the predetermined range.

For example, in the example shown in FIG. 4, consider the configuration in which the unit section, for which the correlation is to be specified, and two unit sections provided therebefore and thereafter on the road before the intersection I are used as objects for acquiring the reference traffic information, and two unit sections from the intersection I on the roads after the intersection I are used as objects for acquiring the reference traffic information. In this case, assuming a unit section U₁₃ as the unit section for which the correlation is to be specified, unit sections U₁₅, U₁₄, U₁₃, U₁₂, and U₁₁ are used as objects for acquiring the reference traffic information on the road R₁, and unit sections U₂₁, U₂₂, U₃₁, and U₃₂ are used as objects for acquiring the reference traffic information on the roads R₂ and R₃. On the other hand, assuming the unit section U₁₁ as the unit section for which the correlation is to be specified, the unit sections U₁₃, U₁₂, and U₁₁ are used as objects for acquiring the reference traffic information on the road R₁, and the unit sections U₂₁, U₂₂, U₃₁, and U₃₂ are used as objects for acquiring the reference traffic information on the roads R₂ and R₃.

Next, the control unit 20 acquires the correlation between the motion information 30a on the unit section and the leaving direction, for which the correlation is to be specified, and the reference traffic information (Step S120). For example, in the case where the unit section U₁ₙ is used as an object for specifying the correlation, the coefficients shown in the following formula (1) are specified by multiple regression analysis.

$$Formula 1$$

$${V}_{1 nm} = {a}_{1 nm} \cdot {S}_{1 n - 2} + {b}_{1 nm} \cdot {S}_{1 n - 1} + {c}_{1 nm} \cdot {S}_{1 n} + {d}_{1 nm} \cdot {S}_{1 n + 1} + {e}_{1 nm} \cdot {S}_{1 n + 2} + {x}_{1 nm} \cdot {S}_{21} + {y}_{1 nm} \cdot {S}_{22} + {s}_{1 nm} \cdot {S}_{31} + {t}_{1 nm} \cdot {S}_{32} \qquad ( 1 )$$

Here, capital V denotes a speed of vehicle indicated by the motion information 30a, and capital S denotes an average speed indicated by the reference traffic information. Lowercase letters a, b, c, d, e, x, y, s, and t denote coefficients of the objects to be specified. Specifically, a, b, d, and e denote coefficients by which the average speed is multiplied in the unit section on the road R₁ located anteriorly by two sections, anteriorly by one section, posteriorly by one section, and posteriorly by two sections, respectively, from the unit section which is used as an object for specifying the correlation; c denotes a coefficient by which the average speed in the unit section, for which the correlation is to be specified, is multiplied; x and y denote the coefficients by which the average speed in the unit section on the road R₂ after the intersection is multiplied; and s and t denote the coefficients by which the average speed in the unit section on the road R₃ after the intersection is multiplied.

Note that the subscripts of the coefficients and the speed of vehicle, first two digits denote unit sections (n is a natural number) and last digits denote the leaving directions from the intersection. The subscripts of the average speed denote the unit sections (n is a natural number). Specifically, in the formula (1), V_{1 nm} is the motion information 30a in the unit section U₁ₙ, and denotes the motion information 30a on the vehicle leaving in the leaving direction expressed by m from the intersection I (e.g., right or left in the example shown in FIG. 4). Since the subscripts of the coefficients a, b, c, d, e, x, y, s, and t are also 1 nm, each coefficient is specified for each leaving direction from the intersection in each unit section. Moreover, in the example shown in the formula (1), the average speeds S in the respective two unit sections (U₁ₙ₋₂, U₁ₙ₋₁, U₁ₙ₊₁, U₁ₙ₊₂) before and after the unit section U₁ₙ and the two unit sections (U₂₁, U₂₂ and U₃₁, U₃₂) after the intersection I are considered. Since the average speed S is defined regardless of the leaving direction from the intersection I, the average speed S has only two-digit subscript which denotes the unit section. In the case where no unit section, for which the reference traffic information is to be acquired, is present, the terms regarding the unit section is not considered in the formula (1). For example, in the case where the unit section for which the correlation is to be specified is the unit section U₁₁ as shown in FIG. 4, the terms including the coefficients a, b are not considered. After specifying the coefficients in the above formula (1), the control unit 20 records the information indicating the coefficients on the recording medium 30 as the correlation information 30b.

In the above formula (1), n is a natural number, and is defined to be larger as the distance from the intersection I, which is the base point on the road R₁, increases. Therefore, as shown in the left-hand side of the formula (1), the speed of the vehicle V indicated by the motion information 30a is the speed of vehicle in each unit section on the road from a location before the vehicle arrives at the intersection I to the intersection I. On the other hand, as shown in the right-hand side of the formula (1), the average speed S indicated by the traffic information is the average speed in each unit section on the road from a location before the vehicle arrives at the intersection I to a location after the intersection I. Summing up, the formula (1) defines the correlation between the reference traffic information and the motion information in view of the effect of the traffic condition before and after the intersection I.

After acquiring the correlation with the reference traffic information in Step S120, the control unit 20 determines whether the correlation has already been specified for all the leaving directions in all the unit sections on the roads before and after the intersection, for each of the predetermined intersections (Step S125). The control unit 20 repeats Step S100 and the processing after Step S100 until the control unit 20 determines that the correlation has already been specified for all the leaving directions in all the unit sections on the roads before and after the intersection, for each of the predetermined intersections in Step S125.

(1-4) Processing for Acquiring Estimated Motion Information

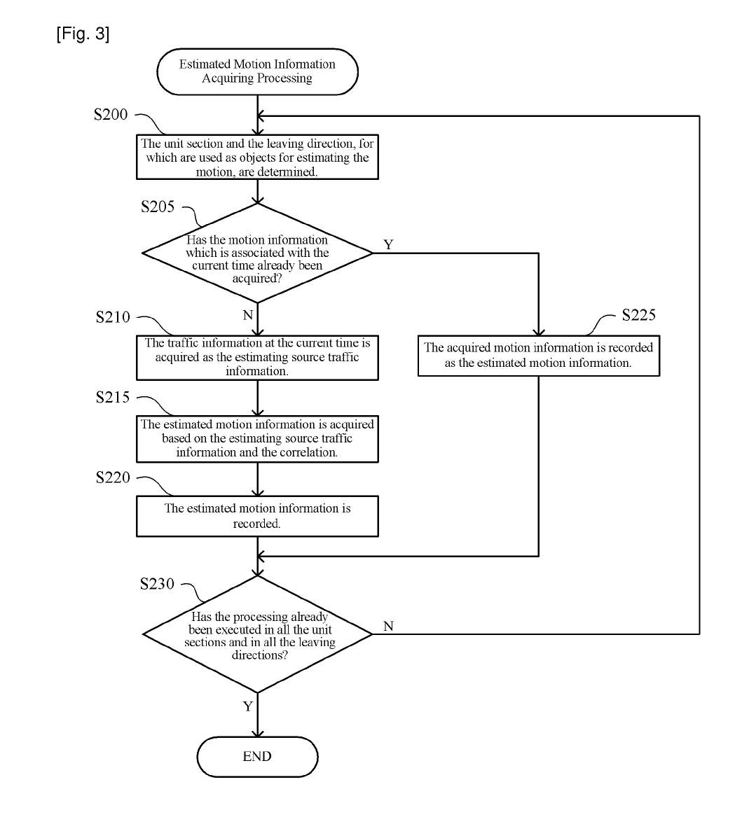

Next, a processing for acquiring the estimated motion information, which is conducted such that the vehicle motion estimating device 10 estimates the motion of the vehicle based on the correlation in the aforementioned configuration, will be described in detail. FIG. 3 is a flow chart illustrating the processing for acquiring the estimated motion information. The control unit 20 regularly conducts (e.g., once every five minutes) the processing for acquiring the estimated motion information via the processing of the estimated motion information acquiring unit 21d. In this processing, the control unit 20 determines the unit section and the leaving direction for which the motion is to be estimated (Step S200). In this embodiment, for the predetermined intersection, the plurality of unit sections are set on the roads before and after the intersection, and the correlation is defined for each leaving direction from the intersection in each unit section. Thus, in this embodiment, the estimated motion information is acquired for each combination of the unit section and the leaving direction, and the control unit 20 uses the combination in which the correlation is not yet specified, among the combinations of the unit sections and the leaving directions, as an object for estimating the motion.

Next, the control unit 20 determines whether the motion information associated with the current time (estimate time) has already been acquired (Step S205). Specifically, the control unit 20 determines whether the motion information 30a has already been acquired with reference to the recording medium 30. The motion information 30a is on the unit section and the leaving direction, which are used as objects for estimating the motion, and the time information, which is associated with the motion information 30a, indicates any time in the predetermined period prior to the current time (including the current time).

In Step S205, in case of not determining that the motion information 30a associated with the current time has already been acquired, the control unit 20 estimates the motion of the vehicle based on the correlation information 30b. For that purpose, the control unit 20 first acquires the traffic information at the current time as the estimating source traffic information from the traffic information providing device 50 (Step S210). Note that the estimating source traffic information is acquired for the plurality of unit sections, and the relation between the unit section, which is used as an object for estimating the motion, and the plurality of unit sections, which are used as objects for acquiring the estimating source traffic information, is similar to the relation between the unit section, which is used as an object for specifying the correlation, and the plurality of unit sections, which are used as objects for acquiring the reference traffic information. For example, in the example shown in FIG. 4, in the case where the unit section U₁₃ is the unit section which is used as an object for estimating the motion, the unit sections U₁₅, U₁₄, U₁₃, U₁₂, and U₁₁ are used as objects for acquiring the estimating source traffic information on the road R₁, and the unit sections U₂₁, U₂₂, U₃₁, and U₃₂ are used as objects for acquiring the estimating source traffic information on the roads R₂ and R₃. In the case where the unit section U₁₁ is the unit section which is used as an object for estimating the motion, the unit sections U₁₃, U₁₂, and U₁₁ are used as objects for acquiring the estimating source traffic information on the road R₁, and the unit section U₂₁, U₂₂, U₃₁, and U₃₂ are used as objects for acquiring the estimating source traffic information on the roads R₂ and R₃.

After acquiring the estimating source traffic information, the control unit 20 acquires the estimated motion information based on the acquired estimating source traffic information and the correlation which is specified for the unit section that is used as an object for estimating the motion (Step S215). Specifically, the speed of vehicle is acquired by multiplying the average speed, which is indicated by the estimating source traffic information, by the coefficients, which are indicated by the correlation information 30b, and adding the resultant values as in the right-hand side of the formula (1). The correlation is defined in view of the effect of the traffic condition before the arrival at the intersection I and after the passage of the intersection I, as described above. Therefore, the estimated motion information is acquired based on the estimating source traffic information, which is provided from a location before the vehicle arrives at the intersection I to a location after the vehicle passes through the intersection I, and the correlation, and thereby the motion of the vehicle can be estimated in view of the effect of the traffic condition before and after the arrival at the intersection I. As a result, the motion of the vehicle can be accurately estimated. After acquiring the speed of vehicle as the estimated motion information as described above, the control unit 20 records the information indicating the speed of vehicle on the recording medium 30 as the estimated motion information 30c (Step S220).

On the other hand, in the Step S205, in case of determining that the motion information 30a associated with the current time has already been acquired, the control unit 20 records the speed of vehicle indicated by the acquired motion information 30a on the recording medium 30 as the estimated motion information 30c (Step S225). Then, the control unit 20 determines whether the processing to acquire the estimated motion information is executed for all the leaving directions in all the unit sections which are set on the roads before and after the intersection, for each of the predetermined intersections (Step S230). Moreover, the control unit 20 repeats Step S200 and the processing after Step S200 until the control unit 20 determines that the processing to acquire the estimated motion information is executed for all the leaving directions in all the unit sections which are set on the roads before and after the predetermined intersections, for each of the predetermined intersections. The control unit 20 transmits the estimated motion information 30c to the vehicle C in response to the request to send the estimated motion information 30c from the vehicle C. The estimated motion information 30c transmitted to the vehicle C is recorded on the recording medium 300 as estimated motion information 300b in the vehicle C. Accordingly, even in the case where there is no vehicle traveling on roads, the vehicle C can use the estimated motion information 300b associated with the motion of the vehicle.

### (2) Other Embodiments

The foregoing embodiments are merely examples for implementing the invention, and other various embodiments can be employed as long as the estimated motion information is acquired from the estimating source traffic information based on the correlation between the predefined motion information and the reference traffic information. For example, the motion information may be any information as long as the information is associated with the motion of the vehicle in traveling on the roads, and may be the information directly or indirectly indicating the motion of the vehicle. The former would be the information on the positions of the vehicle, and the latter would be the information on the results of the motion of the vehicle (e.g., the time required in the predetermined section) and the conditions which affect the motion of the vehicle (e.g., the degree of traffic jam in the predetermined section).

Moreover, the time information may be any information as long as the information indicates the time associated with the motion information, and may indicate the time when the motion information is created or transmitted, or the time when the vehicle C or the control unit of the vehicle motion estimating device 10 acquires the motion information.

The traffic information may be any information as long as the information indicates the traffic condition which affects the vehicle traveling on the roads, and may be the information indicating the condition which affects the motion of the vehicle, or may be the information indicating the affected motion of the vehicle. In the former case, for example, the degree of traffic jam in the predetermined section would be included in the traffic information, and in the latter case, for example, the positions of the vehicle and the time required in the predetermined section would be included therein.

The reference time may be any time as long as the time is specified by the time information. Specifically, when the traffic condition affects the motion of the vehicle at a given time, such a given time may be set at the reference time. Therefore, whenever the traffic condition indicated by the reference traffic information affects the motion of the vehicle, the time prior to and after the time indicated by the time information can be set at the reference time.

Moreover, the estimate time is not limited to the current time. A desired time which is different from the time indicated by the time information may be defined as the estimate time in the state where the motion information which is associated with the time indicated by the time information has already been acquired by the vehicle motion estimating device 10. For example, in the configuration in which based on certain estimating source traffic information, the estimated motion information associated with the estimating source traffic information is acquired in advance, any time when the traffic condition indicated by the certain estimating source traffic information occurs may be set at an estimate time. Note that the estimating source traffic information may be any information as long as the information indicates the traffic condition which affects the motion of the vehicle at the estimate time, and may be the traffic information at the same time as the estimate time or the traffic information in the time zone which may affect the estimate time.

Moreover, the estimated motion information may be acquired by specifying the correlation without setting the unit section. For example, the present invention may employ the configuration in which the correlation is specified based on the continuous change of the motion of the vehicle on the roads before and after the intersection and then the estimated motion information is acquired based on the correlation.

Moreover, the unit section may be any section as long as the section constitutes the minimum section to define each of the motion information, the estimated motion information, the reference traffic information, and the estimating source traffic information, and may be a section divided by unit distance or a section which is set on the roads in advance and divided by any distance. In the case where the motion information, the estimated motion information, the reference traffic information, and the estimating source traffic information include either the time required for the vehicle traveling in the predetermined section or the degree of traffic jam in the predetermined section, the time required and the degree of traffic jam can be easily defined by employing the configuration in which the time required and the degree of traffic jam are defined for each unit section.

Moreover, the correlation may indicate any relation between the reference traffic information and the motion information, and the various relations can be acquired as the correlation as long as the estimated motion information can be acquired from the estimating source traffic information. Specifically, considering that the motion information and the reference traffic information are converted into numerical values, and a linear combination of the value given by the reference traffic information on each unit section provides the motion information. Thus, the correlation can be easily defined by the coefficients used in the linear combination. Each coefficient can be specified by learning using neural network model, various approximation methods, or the like, in addition to multiple regression analysis.

Moreover, the present invention may employ the configuration in which the motion information associated with the combinations of the reference traffic information on the plurality of unit sections is specified to establish the correlation. In the case where the traffic information is defined for each section constituted by the plurality of unit sections, the combinations of the traffic information for each section constituted by the plurality of unit sections may vary by the time. If the traffic information has the same pattern in the plurality of unit sections, the motions of the vehicle associated with the traffic information are estimated to be similar motions. Therefore, in the case where the reference traffic information is considered as an occurrence pattern of the traffic information for the plurality of unit sections, the correlation can be defined only by associating the reference traffic information with the motion information. As a result, the correlation can be very easily defined.

For example, assume that the information (any of vacancy, congestion and traffic jam) gradually indicating the degree of traffic jam in each of the unit sections U₁₁ to U₁₅, U₂₁, U₂₂, U₃₁ and U₃₂ at the intersection I shown in FIG. 4 is used as the traffic information. The information indicating the association between the combinations of the degree of traffic jam in each unit section at a certain time and the motion information (the speed of vehicle or the like) at such a certain time is defined as the correlation. Then, referring to the correlation, the motion information which is associated with the combinations of the degree of traffic jam given by the current traffic information which is acquired as the estimating source traffic information, is acquired to use as estimated motion information. With this configuration, the correlation can be very easily specified.

Furthermore, the motion information may be defined for each traffic lane of the road where the vehicle traveled. For example, consider the configuration in which the motion information including the information indicating the traffic lane of the road where the vehicle traveled is acquired from the plurality of vehicles. Moreover, the motion information is classified by traffic lane, and the correlation is acquired for each classification of the traffic lane. Then, the estimated motion information on the traffic lane, which is associated with the classification, is acquired based on the estimating source traffic information and the correlation for each classification.

Even the same traffic information, the condition indicated by the traffic information may affect the vehicles for each traffic lane in which the vehicle traveled in different ways. For example, in the case where heavy traffic is present on one lane of four-lane while less traffic is on the other lane, the vehicles have different motions depending on the traffic lane in which the vehicle traveled. In addition, in this case, the vehicles traveling in the same traffic lane have the similar motion. Thus, in the case where the motion information is classified by traffic lane to acquire the correlation for each classification, it is possible to specify the correlation, based on which the estimated motion information can be accurately acquired from the estimating source traffic information. As a result, the estimated motion information can be more accurately specified for each traffic lane. Note that the traffic information may or may not include the information indicating the traffic lane of the road where the vehicle traveled.

Moreover, the aforementioned embodiments employ the configurations in which the motion of the vehicle before and after the intersection is acquired, but, of course, may be configured to estimate the motion of the vehicle before and after other features.

Furthermore, in the aforementioned embodiments, the unit section by the unit distance is set on the roads before and after the intersection to define the reference traffic information and the motion information, but the reference traffic information and the motion information may be defined for different sections. For example, one of the reference traffic information and the motion information may be defined for each unit section and the other may be defined for each road section specified by node of map information.

In the case where the motion information is defined for each unit section and the reference traffic information is defined for each road section specified by node of map information, some or all values given by the reference traffic information are the same in the above formula (1). For example, in the case where the unit sections U₁ₙ₋₂ to U₁ₙ₊₂ are included in one road section, all the average speed S₁ₙ₋₂, S₁ₙ₋₁, S₁ₙ, S₁ₙ₊₁, and S₁ₙ₊₂ indicated by the reference traffic information have the same value in the formula (1). Likewise, in the case where the unit sections U₂₁ and U₂₂ are included in one road section, all the average speed S₂₁ and S₂₂ indicated by the reference traffic information have the same value, and in the case where the unit sections U₃₁ and U₃₂ are included in one road section, all the average speed S₃₁ and S₃₂ indicated by the reference traffic information have the same value. Of course, the correlation between the reference traffic information on the plurality of road sections and the motion information on each unit section may be specified. Moreover, the motion information may be defined for each road section, and hence the present invention can employ the various configurations.

1. A vehicle motion estimating device comprising:
a motion information acquiring unit to perform a function for acquiring motion information, which is associated with a motion of a vehicle on a unit section on a road where the vehicle traveled, along with time information, the motion information including information, which indicates a leaving direction from an intersection in the case where the vehicle passes through the intersection, from a plurality of vehicles which traveled an identical road before passing through the intersection;
a reference traffic information acquiring unit to perform a function for acquiring reference traffic information which is traffic information on a plurality of unit sections which include said unit section itself and unit sections before and after said unit section, at a reference time which is specified by the time information from a traffic information providing device which constantly provides the traffic information;
a correlation specifying unit to perform a function for classifying the motion information by leaving direction, and a function for specifying a correlation between the motion information on the unit section and the reference traffic information on the plurality of unit sections, the correlation being specified in association with the leaving direction for the classified motion information; and
an estimated motion information acquiring unit to perform a function for acquiring estimated motion information on the unit section and on the leaving direction for the classified motion information, which indicates an estimated motion of the vehicle at an estimate time when the motion is estimated, based on estimating source traffic information on the plurality of unit sections at the estimate time and the correlation being specified in association with the leaving direction for the classified motion information, the estimating source traffic information being provided as the traffic information of the estimating source from the traffic information providing device in the case where no motion information is acquired at the estimate time.

2. (canceled)

3. The vehicle motion estimating device according to claim 1, wherein the motion information and the estimated motion information indicate any of a speed of vehicle in the unit section, a time required for the vehicle traveling in the unit section, and a degree of traffic jam in the unit section, and
the reference traffic information and the estimating source traffic information indicate any of a speed of the vehicle in each section constituted by the plurality of unit sections, time required for the vehicle traveling in each section constituted by the plurality of unit sections, and a degree of traffic jam in each section constituted by the plurality of unit sections.

4. The vehicle motion estimating device according to claim 1, wherein the correlation specifying unit performs a function for acquiring coefficients as the correlation in the case where a value associated with the motion information is acquired by adding values, which are obtained by multiplying each value associated with the reference traffic information for each section constituted by the plurality of unit sections, by the coefficients.

5. The vehicle motion estimating device according to claim 1, wherein the correlation specifying unit performs a function for specifying the motion information associated with combination of the reference traffic information on the plurality of unit sections to use the motion information as the correlation

6. (canceled)

7. The vehicle motion estimating device according to claim 1, wherein
the motion information acquiring unit performs a function for acquiring the motion information including information, which indicates a traffic lane of the road where the vehicle traveled, from a plurality of vehicles,
the correlation specifying unit performs a function for classifying the motion information by the traffic lane to acquire the correlation for each classification of the traffic lane, and
the estimated motion information acquiring unit performs a function for acquiring the estimated motion information on the traffic lane associated with the classification, based on the estimating source traffic information and the classified correlation.

8. The vehicle motion estimating device according to any claim 1, wherein
the motion information acquiring unit performs a function for acquiring the motion information on a section from a location before the vehicle arrives at the intersection on the road to the intersection,
the reference traffic information acquiring unit performs a function for acquiring the reference traffic information on a section from a location before the vehicle arrives at the intersection to a location after the vehicle passes through the intersection,
the correlation specifying unit performs a function for acquiring a correlation between the acquired motion information and the acquired reference traffic information, and
the estimated motion information acquiring unit performs a function for acquiring the estimated motion information on a section from a location before the vehicle arrives at the intersection to the intersection, based on the estimating source traffic information and the correlation in the section from the location before the vehicle arrives at the intersection and the location after the vehicle passes through the intersection.

9. A vehicle motion estimating method comprising:
a motion information acquiring step of acquiring motion information, which is associated with a motion of a vehicle on a unit section on a road where the vehicle traveled, along with time information, the motion information including information, which indicates a leaving direction from an intersection in the case where the vehicle passes through the intersection, from a plurality of vehicles which traveled an identical road before passing through the intersection;
a reference traffic information acquiring step of acquiring reference traffic information which is traffic information on a plurality of unit sections which include said unit section itself and unit sections before and after said unit section at a reference time which is specified by the time information from a traffic information providing device which constantly provides the traffic information;
a correlation specifying step of classifying the motion information by leaving direction, and specifying a correlation between the motion information on the unit section and the reference traffic information on the plurality of unit sections, the correlation being specified in association with the leaving direction for the classified motion information; and
an estimated motion information acquiring step of acquiring estimated motion information on the unit section and on the leaving direction for the classified motion information, which indicates an estimated motion of the vehicle at an estimate time when the motion is estimated, based on estimating source traffic information on the plurality of unit sections at the estimate time and the correlation being specified in association with the leaving direction for the classified motion information, the estimating source traffic information being provided as the traffic information of the estimating source from the traffic information providing device in the case where no motion information is acquired at the estimate time.

10. A vehicle motion estimating program for implementing on a computer:
a motion information acquiring function to acquire motion information, which is associated with a motion of a vehicle on a unit section on a road where the vehicle traveled, along with time information, the motion information including information, which indicates a leaving direction from an intersection in the case where the vehicle passes through the intersection, from a plurality of vehicles which traveled an identical road before passing through the intersection;
a reference traffic information acquiring function to acquire reference traffic information which is traffic information on a plurality of unit sections which include said unit section itself and unit sections before and after said unit section at a reference time which is specified by the time information from a traffic information providing device which constantly provides the traffic information;
a correlation specifying function to classify the motion information by leaving direction, and to specify a correlation between the motion information on the unit section and the reference traffic information on the plurality of unit sections, the correlation being specified in association with the leaving direction for the classified motion information; and
an estimated motion information acquiring function to acquire estimated motion information on the unit section and on the leaving direction for the classified motion information which indicates an estimated motion of the vehicle at an estimate time when the motion is estimated, based on estimating source traffic information on the plurality of unit sections at the estimate time and the correlation being specified in association with the leaving direction for the classified motion information, the estimating source traffic information being provided as the traffic information of the estimating source from the traffic information providing device in the case where no motion information is acquired at the estimate time.
